(19) United States
(12) Patent Application Publication
(10) Pub. No.: US 2010/0128576 A1
(43) Pub. Date: May 27, 2010

(54) INTEGRATED MAGNETIC RECORDING HEAD AND NEAR FIELD LASER

(76) Inventors: Alexander W. Fang, Santa Barbara, CA (US); John E. Bowers, Santa Barbara, CA (US); Gregory A. Fish, Santa Barbara, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 12/275,980

(22) Filed: Nov. 21, 2008

(51) Int. Cl. G11B 11/00

(52) U.S. Cl. 369/13.24; G9B/11

(57) ABSTRACT

Apparatuses and methods for making and using laser-assisted magnetic recording devices. A slider for use in a magnetic recording apparatus in accordance with one or more embodiments of the present invention comprises a magnetic recording element having a first pole and a second pole, a magnetic reader, and a laser resonator integrally formed on said slider, having an optical emission point of said resonator positioned between the first pole and the second pole of the magnetic recording element; wherein the laser resonator comprises a semiconductor gain media positioned between a first reflector and a near field optical element having a nonzero optical reflection to the semiconductor gain media.

### BACKGROUND OF THE INVENTION

1. Field of the Invention

The present invention relates generally to magnetic data storage and retrieval, and, more particularly, to laser assisted magnetic recording.

2. Description of the Related Art

In present day magnetic data storage devices, e.g., hard disk drives, etc., the storage density of the magnetic media is governed by the superparamagnetic effect. In magnetic storage, the thermal stability of the stored electric field (bit) decreases as the grain size decreases, and approaches a physical limit called the superparamagnetic limit. Current hard disk technology uses longitudinal recording techniques, which have an estimated limit of 100 to 200 Gbit/in², though this estimate is constantly changing.

One suggested technique to further extend recording densities on hard disks is to use perpendicular recording rather than the conventional longitudinal recording. This approach, however, changes the geometry of the disk and alters the strength of the superparamagnetic effect. Perpendicular recording is predicted to allow information densities of up to around 1 Tbit/in² (1024 Gbit/in²).

Another technique in development is the use of Heat Assisted Magnetic Recording (HAMR) drives, which use materials that are stable at much smaller sizes. However, these data storage devices require heating before the magnetic orientation of a bit can be changed.

In order to function, the data write head must apply heat in a highly localized spot on the recording disk in addition to a localized magnetic field of a conventional magnetic recording device. The related art makes use of several embodiments where a semiconductor laser is coupled to an optical element capable of producing subwavelength sized focused spots in its transmitted nearfield (a solid immersion lens, an aperture, plasmonic structure or combination thereof). The coupling of an optical element to the laser has been performed through free space or via an optical fiber or waveguide or grating. In all cases the optical laser source does not require reflected optical power from the near field element in order to oscillate. This arrangement creates inefficiency as the light that is not transmitted through the aperture or plasmonic structure is lost.

Other related art teaches of the use of an apertured laser source integrated on a recording head, however, this approach makes use of an absorbing aperture to create the near field laser source. Absorption of the un-transmitted light leads to the same inefficiencies of the other related techniques

Other related techniques teach the use of a reflecting aperture integrated onto a semiconductor laser to avoid the loss of the reflected light, however the structures are not integrated with magnetic recording and reading apparatus, or laser structures having a nearfield aperture integrated with a magnetic recording apparatus. However, these techniques require the write head to be fabricated with the semiconducting substrate required for the laser rather than solely an optimized material for the formation of the head. Furthermore, this limitation forces emission of the nearfield output to be adjacent to the write head poles which reduces the magnetic field strength compared to being located between them. These limitations compromise the intended benefits.

It can be seen, then, that there is a need in the art for a high density data storage device.

### BRIEF SUMMARY OF THE INVENTION

The present invention provides an laser assisted magnetic recording system which includes a near field laser resonator and magnetic write coil formed on a conventional magnetic drive head substrate using thin film wafer scale processes.

The present invention comprises apparatuses and methods for making and using laser-assisted magnetic recording devices.

A slider for use in a magnetic recording apparatus in accordance with one or more embodiments of the present invention comprises a magnetic recording element having a first pole and a second pole, a magnetic reader, and a laser resonator integrally formed on said slider, having an optical emission point of said resonator positioned between the first pole and the second pole of the magnetic recording element; wherein the laser resonator comprises a semiconductor gain media positioned between a first reflector and a near field optical element having a nonzero optical reflection to the semiconductor gain media.

Such a slider further optionally comprises the laser resonator comprising a transparent dielectric optical waveguide, the laser resonator comprising a transparent semiconductor optical waveguide, and a substrate of the semiconducting gain media being removed.

A method of operating a slider for use in an magnetic recording apparatus in accordance with one or more embodiments of the present invention comprises applying a predetermined current to a nearfield laser resonator during a write operation of the magnetic recording apparatus, creating a predetermined sequence of marks on a recording media with the nearfield laser resonator and the magnetic recording apparatus, reading the predetermined series of marks, and modifying the predetermined current when the series of marks is improperly read during a read operation of the magnetic recording apparatus.

A laser-assisted magnetic recording device in accordance with one or more embodiments of the present invention comprises a magnetic recording head for creating a local magnetic field at a record point on a magnetic storage media, and a semiconductor gain media, having an optical emission point directed toward the record point of the magnetic recording head, wherein the semiconductor gain media heats the record point on the magnetic storage media to substantially near the Curie temperature of the magnetic storage media.

Such a device further optionally comprises the semiconductor gain media further comprising a waveguide and a near field optical element, the waveguide being a transparent semiconductor optical waveguide, the semiconducting gain media comprising a dielectric optical waveguide, and the semiconductor gain media being transparent.

An aspect of the present invention is that the near field optical element (a solid immersion lens, an aperture, plasmonic structure or combination thereof) is part of the laser resonator and designed so that a substantial portion of the light not transmitted by the near field element is reflected into a guided mode of the resonator to be stored in the laser cavity that is integrated on a magnetic read/write head slider. This resonant enhancement of the transmitted light will significantly decrease the required electrical power needed to drive the integrated near field laser portion of the laser assisted magnetic recording head.

An aspect of this present invention is that the light emission point of the near field optical element is located between the two poles that form a magnetic write coil rather than adjacent to them.

An aspect of the invention is that the slider that contains the near field laser and magnetic recording coil can be formed from a non-semiconductor material with mechanical properties optimized for an air bearing.

An aspect of this invention is that the nearfield optical element can be fabricated either on or from non-semiconductor materials while remaining a reflective element of the laser resonator.

An aspect of this invention is that the nearfield optical element can be fabricated in location spatially separated from the semiconductor gain while remaining a reflective element of the laser resonator.

An aspect of the present invention is to provide a method of operating an integrated magnetic recording head and near field laser where the current applied to the laser during a write operation is determined by using the magnetic read pole to verify the presence of a stable written marks and increase the current to the laser if the mark or series of marks was not written correctly.

### BRIEF DESCRIPTION OF THE DRAWINGS

Referring now to the drawings in which like reference numbers represent corresponding parts throughout:

FIG. 1 illustrates a perspective view of a laser assisted magnetic recording head in accordance with one or more embodiments of the of the present invention;

FIG. 2 illustrates a side sectional view taken through line AA′ of FIG. 1;

FIG. 3 is a perspective view of a laser assisted magnetic recording head similar to the embodiment shown in FIG. 1 where the transparent dielectric optical waveguide is replaced with a transparent semiconductor optical waveguide;

FIG. 4 is a perspective view of a laser assisted magnetic recording head similar to the embodiment shown in FIG. 3 where the near field optical element is an aperture or plasmonic structure formed on the semiconducting media that has been made transparent to the emission wavelength of the resonator;

FIG. 5 is a perspective view of a laser assisted magnetic recording head similar to the embodiment shown in FIG. 4 where the near field optical element is an aperture or plasmonic structure formed on the semiconducting gain media; and

FIG. 6 illustrates a process in accordance with one or more embodiments of the present invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Laser Assisted Magnetic Recording Head

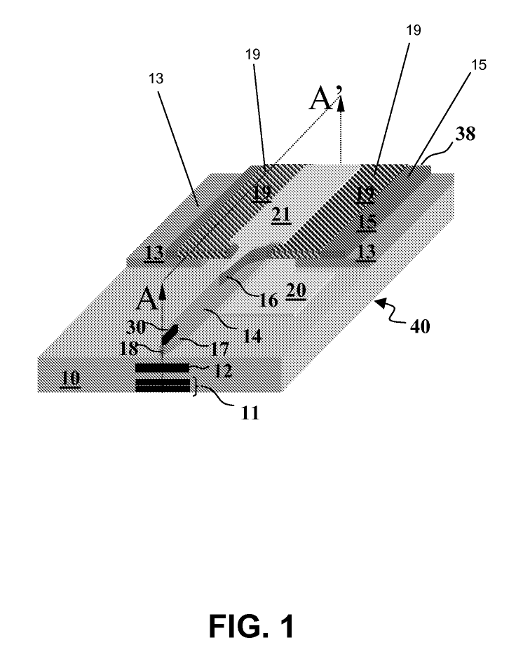

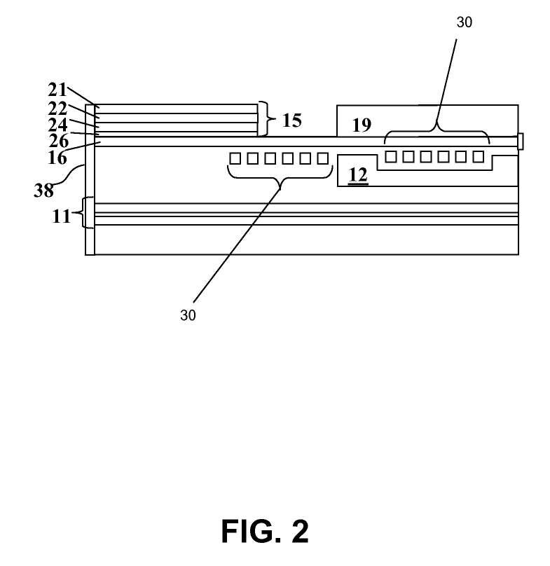

FIG. 1 is a perspective view of a laser assisted magnetic recording head in accordance with one or more embodiments of the of the present invention, and FIG. 2 illustrates a side sectional view taken through line AA′ of FIG. 1.

The integrated slider 40 contains a host substrate 10 that is suitable for the deposition and patterning of thin film based magnetic poles 11, 12, and coils 30 required to form the magnetic read and write functions and air bearing required to slide in close proximity to a magnetic hard disk.

The magnetic return pole 11 is positioned under the location intended for light emission from the near field optical element 17, and/or an optional aperture or plasmonic structure 18. The near field optical element can be a solid immersion lens, an aperture, a plasmonic structure, or combination thereof. A dielectric optical waveguide 14 and the near field optical element 17 are formed in dielectric materials 13 that are deposited onto the substrate 10 and are transparent to the intended wavelength of light. A semiconductor gain media 15 comprising an active material 24 positioned between a p-doped cladding layer 22 and an n-doped cladding layer 26 is bonded to form an optical quality interface between the n-doped cladding and the top of the dielectric waveguide 14.

Current blocking regions 19, aligned to the waveguide 16, are formed on the semiconductor gain media by either removing, or modifying the doping, conductivity, or bandgap of any or all of the layers 22, 24, 26 to preferentially direct current into the area between the current blocking regions 19. An optical mode converter 16 is formed in the semiconductor gain media 15 to convert the optical mode of the dielectric optical waveguide 14 with the semiconductor gain media 15 in contact with it to the optical mode of the diectric optical waveguide 14 without the semiconductor gain media present.

Electrical contacts 21 to the p-doped cladding layer 22 and electrical contacts 20 to the n-doped cladding layer 24 are deposited onto the integrated slider 40. A rear optical reflector 38 is formed on the side of the integrated slider 40 opposite the reflecting near field optical element 17 and/or an optional aperture or plasmonic structure 18 so that the semiconductor gain media 15 is positioned between two reflectors forming a laser resonator. A top magnetic write pole 30 is fabricated above the near field optical element 17 and/or an optional aperture or plasmonic structure 18 so that it is aligned to the light emission point and the magnetic return pole 11.

During operation in a hard disk drive, the integrated slider 40 will be positioned with the optical emission point in close proximity to a magnetic hard disk. During write operations current will be simultaneously applied to the laser electrical contacts 20, 21 and the write coil 30, thereby creating laser emission from the near field optical element 17 or aperture or plasmonic structure 18 directed at the magnetic hard disk. Sufficient current is applied to the laser electrical contacts 20, 21 to provide enough laser light from the nearfield optical element to heat a localized spot on the hard disk's magnetic material to substantially near its Curie temperature, thereby lowering its magnetic coercivity to a level that the magnetic field emitted from the write poles 11, 30 can switch the magnetic orientation of the material, and creating a so called “mark”. At room temperature the magnetic orientation of the mark formed by this operation should remain stable over a significant fraction of the operating life of the drive.

Semiconductor lasers are know to age over time and it is possible that a predetermined laser bias current will not produce enough light output (and therefore heat) for write operation at some point in the life of the drive. Rather than monitor the light with a photodetector, the actual write and read functions of the integrated slider 40 can be used to verify proper mark writing and increase the laser bias current until a successfully written mark sequence is obtained. The predetermined laser bias current can then be changed to the updated value until a subsequent test sequence indicates that a further increase in laser bias current is required. As the lasers age extremely slowly this laser bias current monitoring would occur very infrequently over the life of the drive.

### Alternative Embodiments of the Laser Assisted Head

Transparent Semiconductor Optical Waveguide

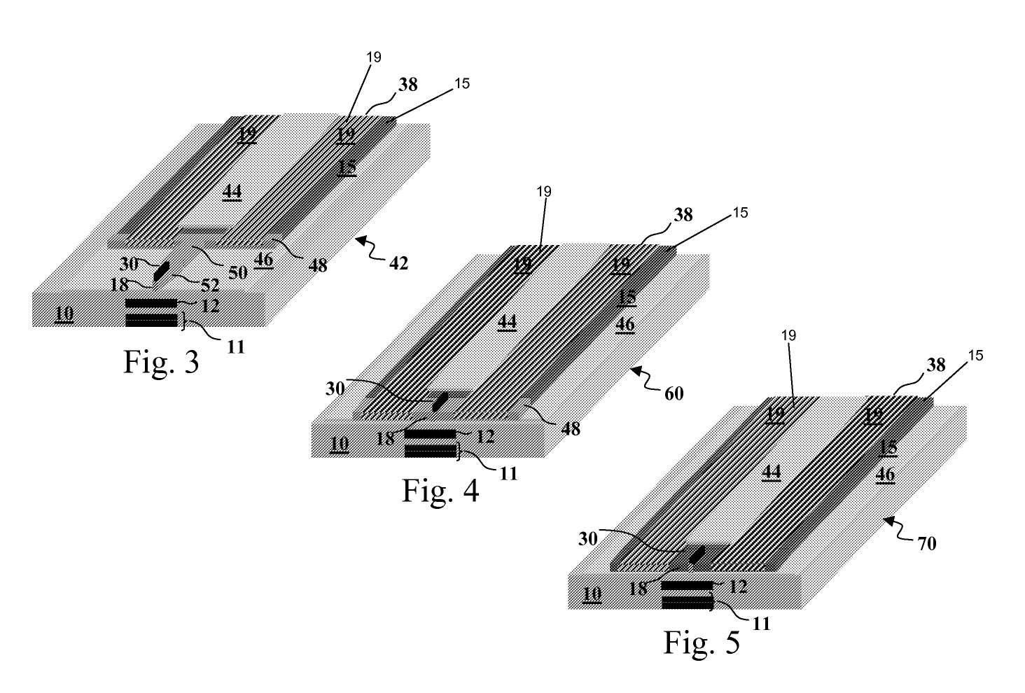

FIG. 3 illustrates an alternate embodiment of the integrated slider 42 where the transparent dielectric optical waveguide 14 has been replaced by a transparent semiconductor optical waveguide 50.

In FIG. 3, the dielectric optical waveguide material 13 is not deposited on the host substrate 10 prior to bonding. The electrical contact 46 to the n-doped cladding layer 24 of the semiconductor gain media 15 is deposited prior to bonding the media to the host substrate 10. A portion of the semiconducting gain media 15 on the emission side of the slider is rendered transparent prior to bonding (region 48).

There are several options for this process to create active and transparent semiconductor regions, e.g., quantum well intermixing, butt joint regrowth, offset quantum well integration or selective area growth, or other processes, without departing from the scope of the present invention.

A semiconductor optical waveguide 50 and semiconductor nearfield optical element 52 is fabricated in the transparent semiconductor portion 48 of the semiconductor gain media 15. An optional aperture or plasmonic structure 18 can be fabricated in addition to or directly onto the semiconductor optical waveguide 50 in place of the nearfield optical element 52.

The remaining construction of the embodiment of FIG. 3 is similar to the embodiment in FIGS. 1 and 2. Electrical contacts 44 to the p-doped cladding layer 22 deposited onto the integrated slider 42. A rear optical reflector 38 is formed on the side of the integrated slider 42 opposite the reflecting semiconductor near field optical element 52 and/or an optional aperture or plasmonic structure 18 so that the semiconductor gain media 15 is positioned between two reflectors forming a laser resonator. A top magnetic write pole 30 is fabricated above the near field optical element 52 and/or an optional aperture or plasmonic structure 18 so that it is aligned to the light emission point and the magnetic return pole 11.

Embodiment Without Waveguide or Nearfield Element

FIG. 4 illustrates an alternate embodiment of the integrated slider 60 of the present invention where the semiconductor optical waveguide 50 or semiconductor nearfield element 52 is not formed.

The transparent semiconductor region 48 is created and light is guided to the emission point by the current blocking regions 19, an aperture or plasmonic structure is formed on the facet and aligned with the magnetic write poles 11, 30 as before.

Embodiment Without Transparent Portion of Gain Media

FIG. 5 illustrates a further embodiment 70 of the integrated slider of the present invention without the transparent portion of the semiconducting gain media 15 and active material being present at the facet.

The advantages of these embodiments of the integrated slider 42, 60, 70 over the embodiment shown in FIG. 1 (40) is that the waveguide mode formed in the semiconductor gain element 15 without the dielectric can have a significantly higher overlap with the gain material 24 without the presence of the dielectric optical waveguide 14. Furthermore an immersion lens-based nearfield optical element made from semiconductor 52 will have a index of refraction more than a factor of 2 larger than a near field optical element formed in dielectric 17. This will result in a corresponding smaller optical spot for the same free space wavelength of light emitted by the near field laser.

### Design Considerations

The density of the magnetic hard disk will be determined by the spot size emitted by the near field laser as the thermal field can be localized to a greater extent than the magnetic field. It is typically desirable that the laser wavelength be as small as possible and numerical aperture of the near field optical element be as large as possible.

Practical constraints on the available semiconductor materials, their performance, and relative costs, make wavelengths shorter than 700 nm unattractive due to inferior optical power and higher costs, however, lasers of any wavelength can be used within the scope of the present invention. Typically, however, emission wavelengths in the 700-900 nm range enables spot sizes<100 nm for nearfield optical elements that have numerical apertures>4, which is achievable with a semiconductor based solid immersion lens used as a near field optical element.

Alternately, other structures, such as apertures or plasmonic structures, can produce sub 100 nm spots within the scope of the present invention. Therefore, the availability, high optical power and reliability of semiconductor lasers at these wavelengths make it an attractive solution that can achieve 1 Tbits/in² of areal density.

By integrating the nearfield optical element into the laser resonator and ensuring the element has a power reflectivity>2% near the wavelength of nearfield transmission, sufficient power can be returned to the cavity to preferentially oscillate at wavelengths near the peak nearfield transmission. The rear reflector 38 should have a reflectivity in excess of 50%, preferably in a spectrally narrow region(<10 nm full width half maximum) centered on the peak wavelength of nearfield transmission. By engineering the reflectivity magnitude and spectral shape, one skilled in the art can create a near field laser with the targeted near field light emission optical power for a minimum electrical drive current.

To facilitate the application of a strong magnetic field collocated with the emitted light it is advantageous to have the emission spot between the write poles as opposed to adjacent to them. To facilitate this it is important to have a relatively thin <5 um optical waveguide (either semiconductor or dielectric). The invention achieves by transferring a thickness of semiconductor gain material less than 5 um in thickness and removing the semiconducting substrate.

In the present system, since the laser and nearfield element are integrally built on the slider, no light deliver system is required to bring the laser emission to the nearfield optical element and it can be formed as part of the resonator so as the light that is not transmitted can be reused. Furthermore, as the semiconductor gain media thickness is less than 5 um it is possible to position the light emission point between the magnetic write poles as opposed to being adjacent to them.

### Process Chart

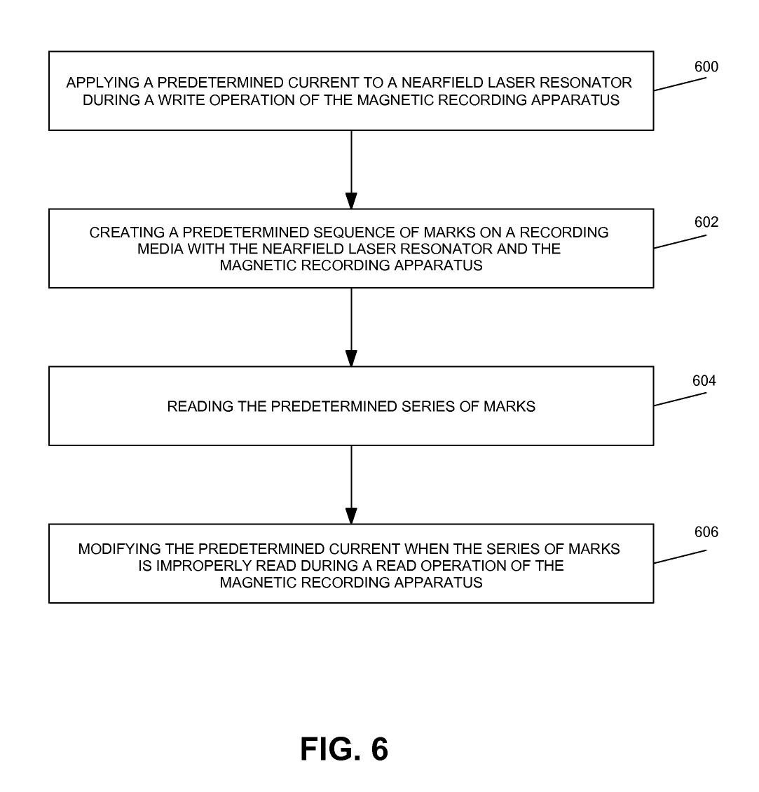

FIG. 6 illustrates a process in accordance with one or more embodiments of the present invention.

Box 600 illustrates applying a predetermined current to a nearfield laser resonator during a write operation of the magnetic recording apparatus.

Box 602 illustrates creating a predetermined sequence of marks on a recording media with the nearfield laser resonator and the magnetic recording apparatus.

Box 604 illustrates reading the predetermined series of marks.

Box 606 illustrates modifying the predetermined current when the series of marks is improperly read during a read operation of the magnetic recording apparatus.

### Conclusion

The present invention comprises apparatuses and methods for making and using laser-assisted magnetic recording devices.

A slider for use in a magnetic recording apparatus in accordance with one or more embodiments of the present invention comprises a magnetic recording element having a first pole and a second pole, a magnetic reader, and a laser resonator integrally formed on said slider, having an optical emission point of said resonator positioned between the first pole and the second pole of the magnetic recording element; wherein the laser resonator comprises a semiconductor gain media positioned between a first reflector and a near field optical element having a nonzero optical reflection to the semiconductor gain media.

Such a slider further optionally comprises the laser resonator comprising a transparent dielectric optical waveguide, the laser resonator comprising a transparent semiconductor optical waveguide, and a substrate of the semiconducting gain media being removed.

A method of operating a slider for use in an magnetic recording apparatus in accordance with one or more embodiments of the present invention comprises applying a predetermined current to a nearfield laser resonator during a write operation of the magnetic recording apparatus, creating a predetermined sequence of marks on a recording media with the nearfield laser resonator and the magnetic recording apparatus, reading the predetermined series of marks, and modifying the predetermined current when the series of marks is improperly read during a read operation of the magnetic recording apparatus.

A laser-assisted magnetic recording device in accordance with one or more embodiments of the present invention comprises a magnetic recording head for creating a local magnetic field at a record point on a magnetic storage media, and a semiconductor gain media, having an optical emission point directed toward the record point of the magnetic recording head, wherein the semiconductor gain media heats the record point on the magnetic storage media to substantially near the Curie temperature of the magnetic storage media.

Such a device further optionally comprises the semiconductor gain media further comprising a waveguide and a near field optical element, the waveguide being a transparent semiconductor optical waveguide, the semiconducting gain media comprising a dielectric optical waveguide, and the semiconductor gain media being transparent.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and the full range of equivalents of the claims.

What is claimed is:

1. A slider for use in a magnetic recording apparatus comprising:
a magnetic recording element having a first pole and a second pole;
a magnetic reader; and
a laser resonator integrally formed on said slider, having an optical emission point of said resonator positioned between the first pole and the second pole of the magnetic recording element; wherein the laser resonator comprises a semiconductor gain media positioned between a first reflector and a near field optical element having a nonzero optical reflection to the semiconductor gain media.

2. The slider of claim 1, where the laser resonator comprises a transparent dielectric optical waveguide.

3. The slider of claim 1, where the laser resonator comprises a transparent semiconductor optical waveguide.

4. The slider in claim 1, where a substrate of the semiconducting gain media has been removed.

5. A method of operating a slider for use in an magnetic recording apparatus, comprising:
applying a predetermined current to a nearfield laser resonator during a write operation of the magnetic recording apparatus;
creating a predetermined sequence of marks on a recording media with the nearfield laser resonator and the magnetic recording apparatus;
reading the predetermined series of marks; and
modifying the predetermined current when the series of marks is improperly read during a read operation of the magnetic recording apparatus.

6. A laser-assisted magnetic recording device, comprising:
a magnetic recording head for creating a local magnetic field at a record point on a magnetic storage media; and
a semiconductor gain media, bonded to the magnetic recording head and having an optical emission point directed toward the record point of the magnetic recording head, wherein the semiconductor gain media heats the record point on the magnetic storage media to substantially near the Curie temperature of the magnetic storage media.

7. The laser-assisted magnetic recording device of claim 6, wherein the semiconductor gain media further comprises a waveguide and a near field optical element.

8. The laser-assisted magnetic recording device of claim 7, wherein the waveguide is a transparent semiconductor optical waveguide.

9. The laser-assisted magnetic recording device of claim 7, wherein the semiconducting gain media comprises a dielectric optical waveguide.

10. The laser-assisted magnetic recording device of claim 6, wherein the semiconductor gain media is transparent.
